(19) United States
(12) Patent Application Publication
(10) Pub. No.: US 2004/0111384 A1
(43) Pub. Date: Jun. 10, 2004

(54) System and method for generating micro-array data classification model using radial basis functions

(76) Inventors: Mi Young Shin, Taejon (KR); Sun Hee Park, Taejon (KR); Sang Kyu Park, Taejon (KR); Kee-Wook Rim, Kyonggi-Do (KR); Amrit L. Goel, New York, NY (US); Ho-Jung Rim, Gangwon-Do (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/446,696

(22) Filed: May 29, 2003

(30) Foreign Application Priority Data
Dec. 7, 2002 (KR) 2002-77571

(51) Int. Cl. G06F 15/18

(52) U.S. Cl. 706/25

(57) ABSTRACT

The present invention relates to a radial basis function classifier generating system and method to classify gene expression pattern appearing on micro-array for functional property. In the present invention, the ‘representation coverage’ to be represented by classifier and the ‘representation precision’, instead of various variables, are set to be input variables and other variables required to generate classifier are automatically determined based on the given values of the input variables. Developer's selection of the values of variables is minimized and the unnecessary trial-and-errors are reduced. Developers understand easily meaning of such input variables and can predict the result of the selection of variables. Accordingly, the trial-and-errors due to meaningless selection of the values of the variables are reduced, so the classifier generation process can be optimized.

This application claims the benefit of the Korean Application No. P - filed on , , which is hereby incorporated by reference.

### BACKGROUND OF THE INVENTION

1. Field of the Invention

The present invention relates to a classifier generating method to classify gene expression pattern appearing on micro-array for its functional property, and more particularly, to a method for automatically generating micro-array data classifier which employs radial basis function model to learn the relationships between gene expression patterns and its functional classes.

2. Discussion of the Related Art

Unlike other learning methods employing non-linear functions, the radial basis function model is characteristic of having both non-linearity and linearity in the model that can be treated separately. To this end, the learning with radial basis function model tends to be relatively faster than others. Further, the learning method provided by the present invention would make it possible to easily generate “good” radial basis function classifiers for given micro-array data without any expert knowledge on the modeling.

To generate a radial basis function classifier, the parameters in the radial basis function model should be determined which include the centers and the widths of basis functions as well as the number of basis functions and their weights.

How to find the optimal values of these parameters efficiently is the key of the radial basis function based learning to generate micro-array data classifiers. To achieve this, the model parameters should be determined so as to reduce undesired trial-and-errors and to minimize arbitrary selections by developers.

Conventionally, the radial basis function models have been employed for various applications. Recently the technology of using a radial basis function model for fluorescence spectrum data to detect pre-cancer of cell organism and degree of its progress is disclosed in the PCT application WO98/24369 entitled ‘Spectroscopic detection of cervical pre-cancer using radial basis function networks’ which belongs to Tumer and three people. The prior patent suggests a method to employ a radial basis function model in pre-cancer prediction technology based on a fluorescence spectrum data of cell organism, but it does not suggest any concrete method to learn an actual radial basis function network.

To determine the parameters of the radial basis function model, in the paper ‘Fast learning in networks of locally-tuned processing units’ disclosed in ‘Neural computation’ by Moody et al., the number of radial basis functions, say k, requires to be selected arbitrarily by users at the beginning. Once k is randomly chosen, the disjoint clusters as many as the number k are generated. Then the centers of k clusters are set to be the centers of the k basis functions while the width of the basis function is determined by P-nearest heuristic applied to the constructed clusters. Thus, in this method, it is almost impossible to reproduce the same learning result for the same learning data, due to the random selection of initial values for the centers of the basis functions required in the beginning of the method.

On the other hand, in the paper ‘Orthogonal least squares learning algorithm for radial basis function networks’ disclosed in ‘IEEE Trans. on Neutral Networks’ by Chen et al., it is suggested that the number of the basis functions is determined differently depending on the determined centers of the basis functions. To determine the center of the basis function, i.e., when selecting the center from the learning data, the data point to minimize the residual error between the prediction value of the result and the actual value is set to be the first center and the next center is set to maximize the reduction of the residual error. This process is repeated, while the basis functions are increased one by one, until it reaches the threshold for the residual error. This method, however, has the disadvantage that the selected centers tend to be very sensitive to the perturbation of the learning data that are referred to in the process of setting the centers of the basis functions.

To summarize, the conventional radial basis function classifier generating methods tend to require input values for various parameters, and further, it is difficult to find the proper values for them since the direct effect of these input values on classification result cannot be easily predicted. Thus, developers cannot avoid making trial-and-errors in order to find the optimal values for the input variables. In addition, in case of including randomness in selecting the input values, it is impossible to reproduce the same classifier on the same data.

### SUMMARY OF THE INVENTION

To overcome this problem, inventors introduced new variables to control the ‘representation coverage’ and ‘representation precision’ of the learning data, of which theoretical base had been discussed in the paper ‘A radial basis function approach for pattern recognition and its applications’ disclosed in ‘ETRI Journal’. By selecting the proper values of these new variables, the parameters of the radial basis function model can be determined automatically based on the selection of these variables.

The present invention, reflecting the above theoretical base, provides an actual classifier generating method that can be practically used for generating micro-array data classifiers in reality.

The present invention is focused on the method of generating a radial basis function based micro-array data classifier that can classify gene expression pattern appearing on micro-array for its functional property, while it substantially obviates one or more problems caused by some limitations and disadvantages of the related current art. More specifically, the objective of the present invention is to provide a schematic method to set various parameters required to generate radial basis function classifiers.

The general idea of the present invention is first to generate in normalized form the learning data including the collected gene expression patterns and their corresponding functional classes, and then to quantify the ‘representation coverage’ of the learning data by a specific number of basis functions, with reference to the ‘representation precision’. Now, if the threshold of the representation coverage is given, the “optimal” number of basis functions that satisfies the given threshold can be automatically determined, in addition to the automatic determination of the center, the width and the weight of the basis functions, which are all the parameters required to generate the classifier using the radial basis functions.

Additional advantages, objectives and features of the invention will be set forth in part in the description which follows, and in part, will become apparent to those having ordinary skill in the art upon examination of the following or may be learned from the practice of the invention. The objectives and some advantages of the invention may be realized and attained by the structure particularly pointed out in the written description and claims hereof as well as the appended figures.

To achieve these objectives and advantages in accordance with the purpose of the invention, as embodied and broadly described herein, the method of generating micro-array data classifier using radial basis functions according to the present invention comprises the steps of: (a) generating the learning data normalized which include gene expression pattern on the micro-array; (b) setting input values for ‘representation coverage’ and ‘representation precision’ of the learning data that are newly introduced input variables in the present invention; (c) obtaining the values of a learning control variable and a basis function width from the given ‘representation coverage’ and the ‘representation precision’; (d) generating a candidate classifier by computing in order the number, the centers and weights of basis functions which meet the set learning control variable and the width; (e) computing validation error of a candidate classifier generated at the step (d) and checking if the generated candidate classifier has the minimal validation error; (f) generating other candidate classifiers by repeating the steps (d and e) with respect to the basis function width readjusted by ‘representation precision’; and (g) determining the classifier which has the minimal validation error as a final classifier.

It should be noted that both the foregoing general description and the following detailed description of the present invention are exemplary and explanatory, which are intended to provide further explanation of the invention as claimed.

### BRIEF DESCRIPTION OF THE FIGURES

The accompanying figures, which are included to provide a further understanding of the invention, illustrate embodiments of the invention and also serve to explain the principle of the invention along with the description. In the figures:

FIG. 1 illustrates a classifier generating system based on the radial basis functions according to the present invention;

FIG. 2 is a flowchart to illustrate a classifier generating method, according to the present invention, to classify gene expression pattern on a micro-array for its functional property;

FIG. 3 illustrates class learning data generator of the present invention;

FIG. 4 illustrates the method of describing gene expression pattern of class learning data of the present invention;

FIG. 5 illustrates the method of describing functional classes, each of which corresponds to gene expression pattern of class learning data of the present invention;

FIG. 6 illustrates input variable setting process for generating classifier with the present invention; and

FIG. 7 illustrates a radial basis function based classifier generator of the present invention.

### DETAILED DESCRIPTION OF THE INVENTION

Now the preferred embodiments of the present invention are addressed in details, along with some illustrative examples and figures.

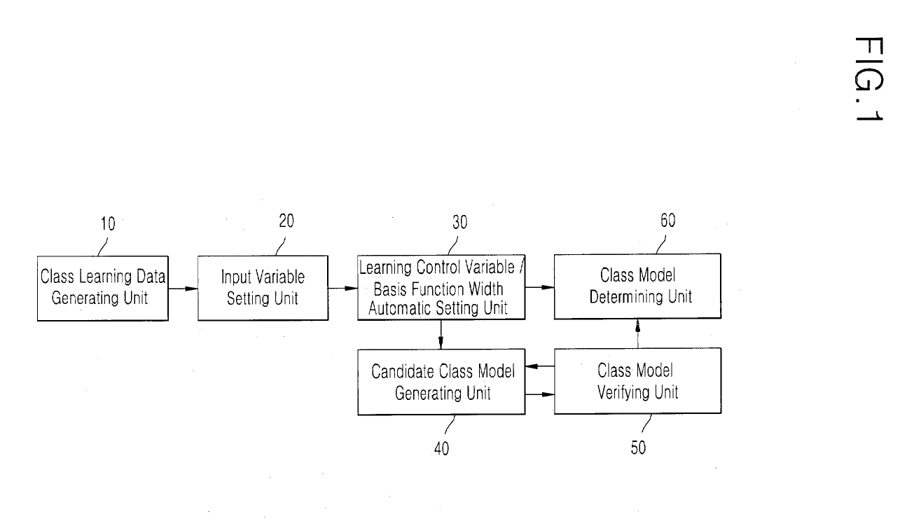

FIG. 1 illustrates a classifier generating system based on the radial basis function according to the present invention.

Referring to FIG. 1, a system of generating micro-array data classifier using radial basis functions according to the present invention includes a class learning data generating unit 10 for generating normalized learning data where a gene expression pattern and its corresponding functional class are presented for each micro-array sample; a learning data input variable setting unit 20 for setting input values for ‘representation coverage’ and ‘representation precision’ that are input variables to generate classifiers; a learning control variable/basis function width automatic setting unit 30 for automatically setting a learning control variable and a basis function width from the inputted ‘representation coverage’ and ‘representation precision’; a candidate classifier generating unit 40 for generating candidate classifiers by automatically determining the number, center and weight of the basis functions, which are parameters related to the radial basis function for the set learning control variables; a classifier validation unit 50 for computing validation error of a generated candidate classifier and checking if the generated candidate classifier has the minimal validation error; and a classifier determining unit 60 determining the classifier with the minimal validation error as a final classifier.

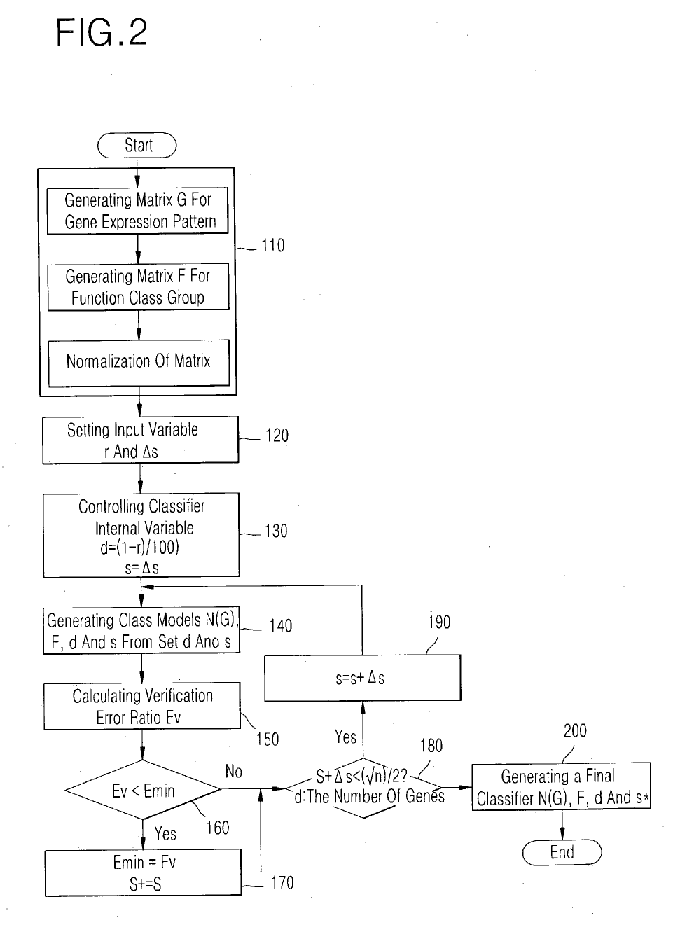

FIG. 2 is a flowchart to illustrate a classifier generating method, based on a radial basis function of the present invention using a system shown in FIG. 1, of classifying gene expression pattern on a micro-array according to its functional class.

Referring to FIG. 2, in the method of the present invention, learning data that include gene expression patterns and their corresponding functional classes for samples, in the form of matrices G and F, are generated by the class learning data generating unit 10. Each component Gᵢⱼ of the matrix G is normalized to be between 0 and 1, which is for data pre-processing (S110).

And then, the input values for ‘representation coverage’ r and ‘representation precision’ Δs are set by the input variable setting unit 20 (S120). Based on these values, the learning control variable/basis function width automatic setting unit 30 determines the control variable d and the width s (S130). The number k of the basis functions, their centers c, and the weights w that are the radial basis function parameters are determined in order and the candidate classifier is generated by the candidate classifier generating unit 40 (S140).

Next, the classifier validation unit 50 computes the validation error Eᵥ of the classifier generated by the candidate classifier generating unit 40 (S150). The validation error Eᵥ is compared with the stored minimal validation error Eₘᵢₙ S160). When the validation error Eᵥ of the generated classifier is less than the stored minimal validation error Eₘᵢₙ, the value Eᵥ is stored into Eₘᵢₙ as a new minimal validation error value (S170).

The basis function width s of the classifier generated in the step S140 of the present invention is increased as much as the inputted ‘representation precision’ and it is determined depending on that the increased basis function width s+Δs is within allowable range (S180). If this value is within the allowable range, the basis function width is updated as s+Δs (S190). The parameter determination processes (S140 to S170) related to the basis functions, for the newly updated basis function width, are repeated to generate candidate classifiers. If the increased basis function width s+Δs is not within the allowable range, the basis function width s* generating the minimal validation error is recognized as the best classifier, so the classifier determining unit 60 generates the classifier with the basis function width s* set in the step S170 in the manner of the step S140, which becomes the final result of the classifier generating method by the present invention (S200).

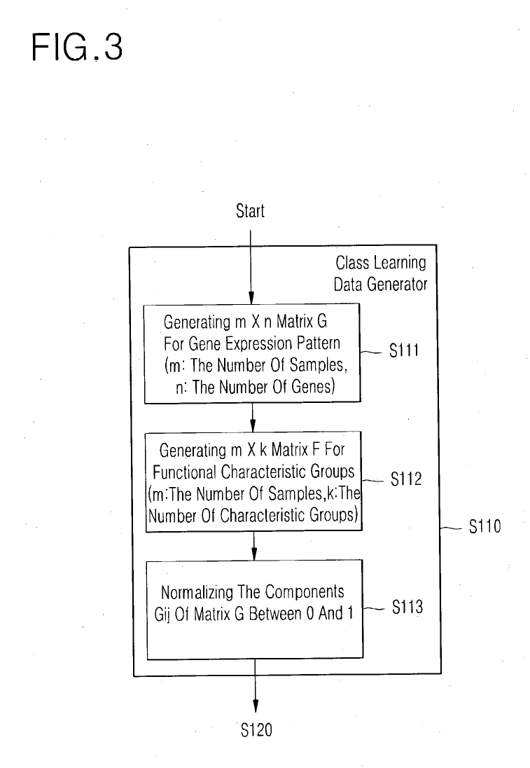

Now the steps, referring to FIGS. 3 to 7, of the classifier generating method by the present invention will be detailed.

A) The first step of generating the normalized class learning data

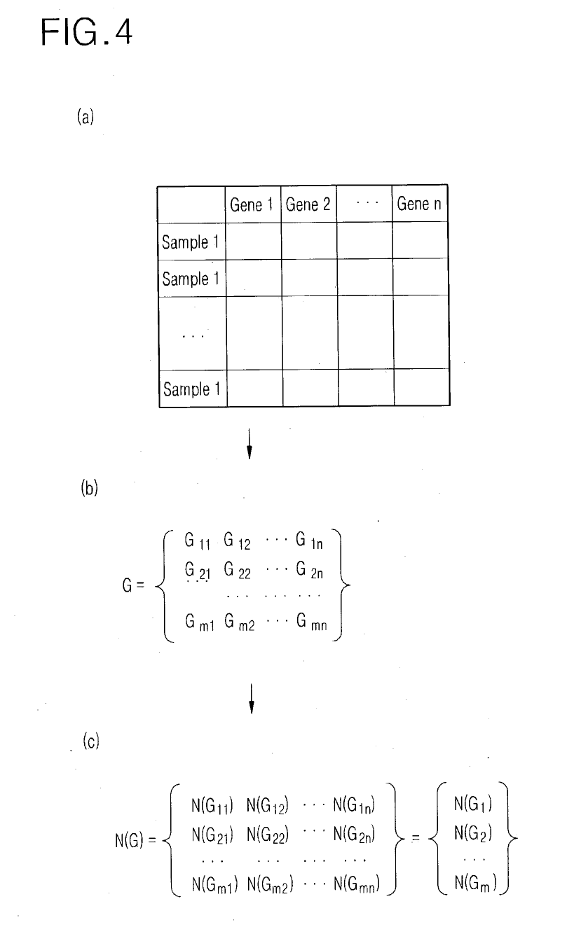

As shown in FIGS. 4a and 4b the gene expression patterns for micro-array samples are described as a matrix G that has the size of the number of micro-array samples m×the number of genes n to generate the normalized class learning data in the embodiment of the present invention (S111).

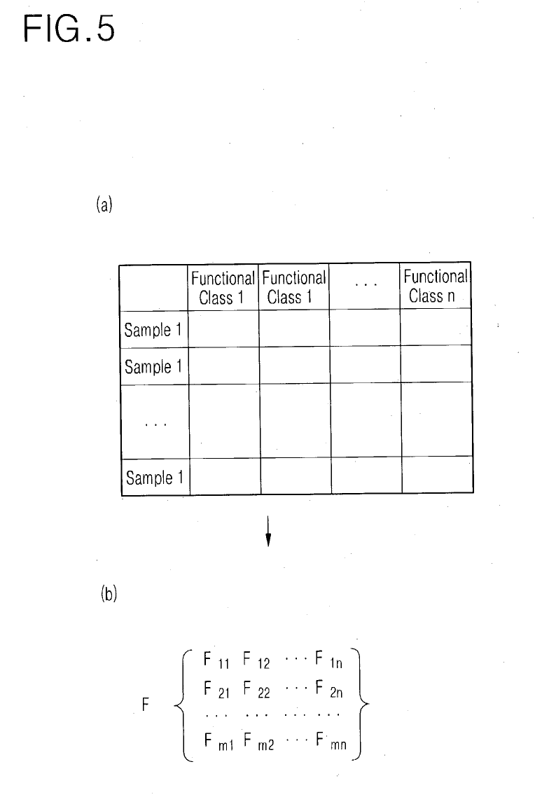

The functional classes for micro-array samples are described as a matrix F that has the size of the number of micro-array samples m×the number of functional classes n as shown in FIGS. 5a and 5b (S112).

Each component Gᵢⱼ of the matrix G as expressed above is normalized to be between 0 and 1 using the following Expression 1, and the matrix N(G) which has normalized components N(Gᵢⱼ) is generated finally as shown in FIG. 4c (S113).

Expression 1

$$N ( {G}_{ij} ) = \frac{{G}_{ij} - min ( {G}_{1 j} , {G}_{2 j} , ⋯ , {G}_{mj} )}{max ( {G}_{1 j} , {G}_{2 j} , ⋯ , {G}_{mj} ) - min ( {G}_{1 j} , {G}_{2 j} , ⋯ , {G}_{mj} )}$$

It should be noted that this normalizing process is required to quantify the ‘representation coverage’ within a finite range.

B) The second step of setting input values for ‘representation coverage’ and ‘representation precision’ that are input variables to generate a classifier.

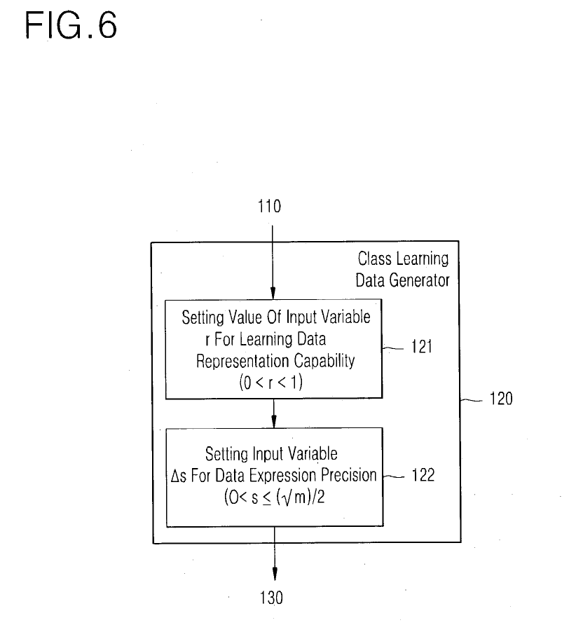

As shown in FIG. 6, the parameter r for the ‘representation coverage’ and the ‘representation precision’ can have the value greater than 0 and less than 1 (S121). When the input variable r is given, the actual ‘representation coverage’ generated by an actual classifier implies r×100%.

In other words, if the variable r=0.99, the ‘representation coverage’ is 0.99×100=99%. Theoretically the value of the ‘representation coverage’ r can be all values between 0 and 1, but in practice the validation error of the generated classifier increases drastically if the value r is less than 0.9.

On the other hand, the variable Δs for the ‘representation precision’ can be any value within the range:

$$0 < Δ s \leq \frac{\sqrt{the number ( n ) of genes}}{2} ( S122 ) .$$

The less the value is, the more detailed analysis is possible. Setting the variable Δs for the ‘representation precision’ affects significantly on determining the radial basis function width s in the third step of the present invention and on determining the number of the repetition for generating candidate classifiers in the fifth step.

C) The third step of automatically setting a learning control variable and a basis function width to generate classifier from the ‘representation coverage’ ‘representation precision’

According to the present invention, when input value is given for the ‘representation coverage’ r, the value for the learning control variable d is automatically determined based on the following Expression 2.

Expression 2

$$d = \frac{1 - r}{100}$$

If the ‘representation precision’ Δs is also given, the value for the radial basis function width s can be determined. That is, the radial basis function width s is increased every time by the Δs in the form of s=Δs, s+Δs, s+Δs+Δs, s+Δs+Δs+Δs, . . . until it is greater than

$$\frac{\sqrt{the number ( n ) of genes}}{2} .$$

This is because the radial basis function width s is bounded to the range:

$$0 < s \leq \frac{\sqrt{the number ( n ) of genes}}{2} .$$

For example, if the inputted representation precision Δs is 0.1 and the number of genes n=4, the value of the basis function width s is allowed within the range of

$$0 < s \leq \frac{\sqrt{4}}{2} = 1$$

according to the above-mentioned rule. Accordingly, the value of the radial basis function width s can be any one of ten different numbers including s=0.1, 0.2, . . . , 0.9. On the other hand, if the input value of the data expression precision Δs 0.3, s can be only three different values including 0.3, 0.6 and 0.9. Therefore, when the value of the data expression precision Δs is small, comparatively detailed analysis is possible.

D) The fourth step of automatically determining the number, the center and the weight of the radial basis functions, which are parameters related to the radial basis functions for the set learning control variable and the set width.

Based on the learning control value d and the radial basis function width s determined at the third step, in the present invention, the classifier is automatically generated by the following process using the matrix G and F that are normalized class learning data generated earlier. The classifier eventually mentioned in the present invention is described by a function shown in Expression 3 where the classification result with respect to an input sample data x is considered to be y. Thus, generating classifier means determining the values of the parameters of this function.

Expression 3

$$y = f ( x ) = {\sum }_{j = 0}^{k} {w}_{j} exp ( - \frac{{‖ x - {c}_{j} ‖}^{2}}{2 {s}^{2}} )$$

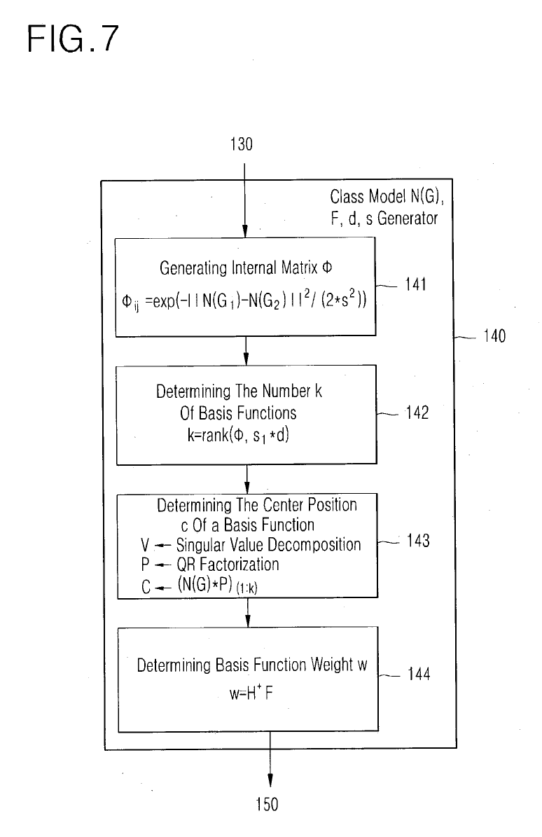

In other words, in order to generate a radial basis function based classifier, as shown in FIG. 7, the values of the parameters of the number k, the centers c, the width s and the weights w of the radial basis functions in the expression 3 should be determined. Since the basis function width s of them has been already determined, the method of determining the values of the parameters of the number k, the center c, and the weight w of the basis functions, except the width s, will be described in this step.

First, to determine the number k of the basis functions, the internal matrix Φ is constructed by Expression 4 using the normalized learning data N(G) generated at the first step and the basis function width s determined at the third step. Expression 4 implies that all the samples N(G₁), N(G₂), . . . N(G₈ₙ) included in N(G) are used as the centers of n basis functions, i.e., c₁, c₂, . . . , cₙ in Expression 3, when k=n. By applying the Expression 4 to all the input samples N(G₁), N(G₂), . . . , N(Gₙ), i.e., for i, j=1. . . n, the matrix Φ can be generated (S141).

Expression 4

$${Φ}_{ij} = exp ( - \frac{{‖ N ( {G}_{i} ) - N ( {G}_{j} ) ‖}^{2}}{2 {s}^{2}} )$$

The matrix Φ generated as mentioned above is used to automatically determine the number k of the basis functions as shown in Expression 5. That is, k is determined as the rank of the matrix Φ which refers to the first singular value s₁ of the matrix Φ and the learning control variable d determined at the third step (S142).

Expression 5

k=rank(Φ,s₁×d)

Next, to determine the center c=c₁, c₂, . . . , cₖ of the k basis functions, the k most proper ones of the samples N(G₁), N(G₂), . . . , N(Gₙ) included in the normalized learning data are selected as the centers in the present invention. Describing in further detail, singular value decomposition is performed on the matrix Φ, i.e., SVD(Φ)=U_{Φ}S_{Φ}V_{Φ}, to find right singular matrix V_{Φ}. By taking the first to kth column vectors v₁, . . . , vₖ of the matrix V_{Φ}, the singular matrix V_{Φ(1:k)}=[v₁, . . . , Vₖ] is obtained. QR factorization is applied to the transposed matrix of the matrix V_{Φ(1:k)} to obtain a permutation matrix P. This obtained permutation matrix P is used to rearrange the columns of the matrix N(G) in order of importance, which is denoted by the matrix Nₚ(G). The input samples used to generate the first to kth column vectors Nₚ(G)₁, . . . , Nₚ(G)ₖ of the matrix Nₚ(G) are selected as the center of the basis function (S143).

Finally, to determine the weights of the k basis functions, the columns of the matrix Φ are rearranged in order of importance using the obtained permutation matrix P to generate a matrix Φₚ. Taking the first to kth column vectors, i.e., Φ_{p(1:k)}, of the matrix Φₚ, we call it the matrix H. The pseudo-inverse of the matrix H is then multiplied to the matrix F generated at the first step, as in Expression 6, to determine the values w=[w₁, . . . Wₖ] of weights of the k basis functions (S144).

Expression 6

w=H° F

E) checking if the generated candidate classifier has the minimal validation error

The classification error of the candidate classifier generated at the previous step on validation data is computed. It is then checked if this validation error is less than the currently stored minimal validation error. If the present validation error is less than the minimal validation error, the value of the present validation error is newly stored as the minimal validation error while the value of the basis function width s producing the minimal validation error is also stored as s*.

F) The sixth step of generating new candidate classifiers with the basis function width readjusted by ‘representation precision’

The basis function width s is increased every time by the inputted Δs, i.e., adjusted in the form of s=Δs, s+Δs, s+Δs+Δs, s+Δs+Δs+Δs, . . . . The increase of the value is allowed until it is greater than

$$\frac{\sqrt{the number ( n ) of genes}}{2} .$$

For each value of the basis function width s=Δs, s+Δs, s+Δs+Δs, s+Δs+Δs+Δs, . . . , the fourth to fifth steps are repeated to generate a new candidate classifier.

G) The seventh step of determining a final classifier

Once computing the validation errors for all the classifiers generated at the previous step and comparing them with the minimal validation error are finished, the optimal classifier can be obtained by using the stored width of s* that generated the minimal validation error to determine the values of radial basis function parameters. That is, as in the manner of the fourth step, the values of the parameters k*, c* and w* are finally determined and the classifier generation process is ended.

As described above, using the method of the present invention, developers do not select directly the values of various parameters related to radial basis functions but a system determines all the parameters automatically except input values of ‘representation coverage’ and ‘representation precision’. The burdens for developers required by the conventional passive parameter selection method and the trial-and-error are greatly reduced. Since only the ‘representation coverage’ and the ‘representation precision’ are required to be inputted, the entire classifier generation process is significantly simplified compared with the convention method required to determine all the various parameters.

Furthermore, since developers understand easily meaning of such input variables and can predict the result of the selection of the input variables, the trial-and-errors due to meaningless selection of the values of the input variables are reduced, so the classifier generation process can be optimized. Finally, the human intervention is minimized and the explicit meaning on input variables are given so that classifier can be easily generated without requiring too much random choices for the parameters.

The description as above is merely an embodiment for illustrating a method of automatically generating a micro-array data classifier using radial basis functions. It will be apparent to those skilled in the art that various modifications and variations can be madein the present invention. Thus, it is intended that the present invention covers the modifications and variations of this invention, provided that they come within the scope of the appended claims and their equivalents.

What is claimed is:

1. A system of generating a micro-array data classifier using radial basis functions, the system comprising:
class learning data generating means for generating normalized learning data which include gene expression patterns on micro-array and their corresponding functional classes for samples;
learning data input variable setting means for setting input values for ‘representation coverage’ and ‘representation precision’ that are input variables to generate classifiers;
learning control variable/basis function width setting means for automatically setting a learning control variable and a basis function width to determine the classifier from the inputted ‘representation coverage’ and the inputted ‘representation precision’;
candidate classifier generating means for generating candidate classifier by automatically determining the number, centers and weights of the basis functions, which are parameters related to the radial basis function for the set learning control variables;
classifier validation means for computing validation error of a generated candidate classifier and checking if the generated candidate classifier has the minimal validation error; and
classifier determining means for determining the classifier producing the minimal validation error among the candidate classifiers generated by the present invention as the final classifier.

2. A method of generating a micro-array data classifier using radial basis functions, the method comprising the steps of:
(a) generating the normalized of class learning data that include gene expression patterns on the micro-array;
(b) setting input values for ‘representation coverage’ and ‘representation precision’ that are input variables to generate classifier based on class learning data;
(c) setting a learning control variable and a basis function width to determine classifier from the ‘representation coverage’ and the ‘representation precision’;
(d) generating a candidate classifier by determining the number, centers and weights of the basis functions, which are parameters related to the radial basis function for the set learning control variables;
(e) computing validation error of the candidate classifier generated at the step (d) and checking if the generated candidate classifier has the minimal validation error;
(f) generating a candidate classifier by repeating the steps (d and e) with the basis function widths readjusted by ‘representation precision’; and
(g) determining the classifier producing the minimal validation error as a final classifier.

3. The method as clamed in claim 2, wherein in the step (b), the range of the input values for the ‘representation precision’ is as follows:
$$0 < Δ s \leq \frac{\sqrt{the number ( n ) of genes}}{2}$$
where the Δs the input values.

4. The method as clamed in claim 2, wherein in the step (c), a learning control variable (d) is set using the ‘representation coverage’ as follows:
$$d = \frac{1 - r}{100}$$
where d is a learning control variable, and
a basis function width (s) of the ‘representation precision’ is set as follows:
s=k * representation precision (Δs) for an arbitrary natural number k while satisfying an expression:
$$0 < s \leq \frac{\sqrt{the number ( n ) of genes}}{2} .$$

5. The method as claimed in claim 2, wherein in the step (d), the number of the basis functions is determined using the basis function width (s) based on an learning control variable (d) as follows:
k=rank(Φ, s₁×d)
where Φ is an internal matrix.

6. The method as claimed in claim 5, the number (k) of the basis functions is used to determine classification result y with respect to an input sample x as follows:
$$y = f ( x ) = {\sum }_{j = 0}^{k} {w}_{j} exp ( - \frac{{‖ x - {c}_{j} ‖}^{2}}{2 {s}^{2}} )$$
where k is the number of the basis functions,
c is the centers,
s is the basis function width and
w is the weights.

7. The method as claimed in claim 5, wherein the internal matrix Φ is found as follows:
$${Φ}_{ij} = exp ( - \frac{{‖ N ( {G}_{i} ) - N ( {G}_{j} ) ‖}^{2}}{2 {s}^{2}} ) .$$

8. The method as claimed in claim 6, wherein the center (c) of the basis functions is found by performing the steps of:
obtaining a right singular matrix (V_{Φ}) by performing singular value decomposition on a matrix Φ;
composing a singular matrix V_{Φ(1:k)=[v}₁, . . . , Vₖ] including column vectors v₁, . . . , vₖ that are the first to kth column vectors of the matrix V_{Φ};
obtaining a permutation matrix P by performing QR factorization on a transposed matrix of the matrix V_{Φ(1:k)};
generating a matrix Nₚ(G) by rearranging the matrix N(G) in order of importance using the transposed matrix P; and
selecting the input samples used in generating the first to kth column vectors Nₚ(G)₁, . . . , Nₚ(G)ₖ of the matrix Nₚ(G) as the centers of the basis functions.

9. The method as claimed in claim 6, wherein the weights (w) of the basis functions are found as follows:
w=H*F
where H is a matrix that includes column vectors Φ_{p(1:k)} as column vectors thereof, the column vectors Φ_{(p(1:k)} are the first to kth column vectors of a matrix Φₚ that is generated by rearranging a matrix Φ in order of importance using transposed matrix P, and F is a matrix representing the number of micro-array samples X the number (k) of functional groups.
